(19) United States
(12) Patent Application Publication
(10) Pub. No.: US 2003/0110065 A1
(43) Pub. Date: Jun. 12, 2003

(54) Method for enhancing sustainability

(75) Inventor: Christopher Francis Michael Twigge-Molecey, Toronto (CA)

Correspondence Address: CAESAR, RIVISE, BERNSTEIN,, COHEN & POKOTILOW, LTD., 12TH FLOOR, SEVEN PENN CENTER, 1635 MARKET STREET, PHILADELPHIA, PA, 19103-2212, US

(73) Assignee: Hatch Associates, Ltd.

(21) Appl. No.: 10/016,708

(22) Filed: Dec. 11, 2001

(51) Int. Cl. G06F 17/60

(52) U.S. Cl. 705/7

(57) ABSTRACT

A method for raising awareness of sustainable development issues involves the identification of a number of indicators which are representative of the sustainability issues relating to an activity, for example an industrial or infrastructural development activity. Data relevant to each of the indicators is collected and analyzed, and a value is then assigned to each indicator which is based on the collected data. The indicator values are then converted to indicator scores which may be either qualitative or quantitative, in order to determine to overall impact of the activity on sustainability. The analysis can be repeated over time to determine the overall impact of the activity on sustainability, and the results can be aggregated to monitor an organization's progress toward sustainability.

### FIELD OF THE INVENTION

The present invention relates to methods for enhancing sustainability of the activities of an organization by incorporating sustainability principles into decision making processes of the organization. The method is particularly suitable for enhancing the sustainability of industrial activities and capital facilities of governments or other institutions.

### BACKGROUND OF THE INVENTION

Sustainable development issues are gaining increasing prominence in all types of industrial activities. One primary goal of sustainable development is to balance economic development and growth with the need to preserve the natural environment for present and future generations. Other goals include reduction of negative social impacts of such activities, and adoption of governance and regulatory systems which promote sustainability.

While very few industries can consider themselves sustainable, efforts are currently underway to lessen the social and environmental impact of existing industrial facilities (“brownfields”) and new facilities (“greenfields”), and to turn development into a positive force for a sustainable future. Many organizations involved in industrial and infrastructure development have developed mission statements or other statements of purpose which espouse the principles of sustainability. However, the problem exists that individuals within an organization making decisions having an impact on sustainability may not be aware of or committed to addressing sustainable development concerns.

Therefore, the need exists for a method for enhancing the sustainability of activities, particularly industrial and infrastructure activities, which is effective to raise awareness of sustainability issues among individuals within an organization, such that sustainability issues are preferably addressed in all decisions which could have an environmental or social impact amongst others.

### SUMMARY OF THE INVENTION

The present invention addresses the problems described above by providing a method for raising awareness of sustainable development issues and to ensure that sustainability issues are addressed when decisions are made which could have an environmental or social impact. The method of the invention also provides a tool for assessing and monitoring the impact on sustainability of an enterprise or institution, of a proposed or intended activity, as well as for reporting the status and contribution toward sustainability of the enterprise or institution resulting from the proposed or intended activity.

The method of the present invention involves the identification of a number of indicators which are representative of the sustainability issues relating to an activity, for example an industrial activity. In this context, such indicators could include material usage, energy usage, emissions, effluents, byproducts, carbon dioxide emissions, use of toxics, social opportunities, social demands and stresses, etc. For example, the indicators relevant to energy usage may include energy use per ton of product, and cost of energy per unit, and the indicators relevant to social opportunities may include measures of engagement with the local community such as number of public meetings held per year or number of hospital beds or school rooms added to a community.

Data relevant to each of the indicators is then collected and analysed, so that a “value” can be assigned to each indicator. For example, specific numerical values can be assigned to represent energy use per ton of product, and to the number of public meetings.

The values for the indicators are then converted to indicator scores. The scores can be qualitative, for example a determination can be made as to whether the value of each indicator will have an improving, neutral or deteriorating influence on the overall environmental impact of the relevant industrial activity. The values of the indicators can also be converted to quantitative indicator scores. These quantitative scores can be arbitrarily assigned numerical values, for example zero for an impact judged to be negative, +1 for a neutral impact and +2 for a positive impact. Different categories can be given different weightings to reflect the relative importance of different indicators to the initiating organization.

The method of the invention is particularly well suited to assessing the environmental impact of capital projects on an existing industrial facility. An analysis as described above can be performed individually for each capital project in order to determine the impact of the project on sustainability. While this type of analysis is important, a major advantage of the present invention is that the results of the analyses for individual capital projects can be aggregated to determine the cumulative effect of all capital projects on the industrial facility. Likewise, the results for all facilities in a division can be aggregated, as can the results for all divisions in an organization, thereby providing an effective method for tracking the organization's progress in addressing sustainability issues. This type of information is very useful for inclusion in annual reports and for public reporting.

### BRIEF DESCRIPTION OF THE DRAWINGS

The invention will now be described, by way of example only, with reference to the accompanying drawings, in which:

FIG. 1 is an example of a checklist used in the method of the present invention; and

FIG. 2 is a graphic representation of an aggregate sustainability score for an organization over a number of categories.

### DETAILED DESCRIPTION OF PREFERRED EMBODIMENTS

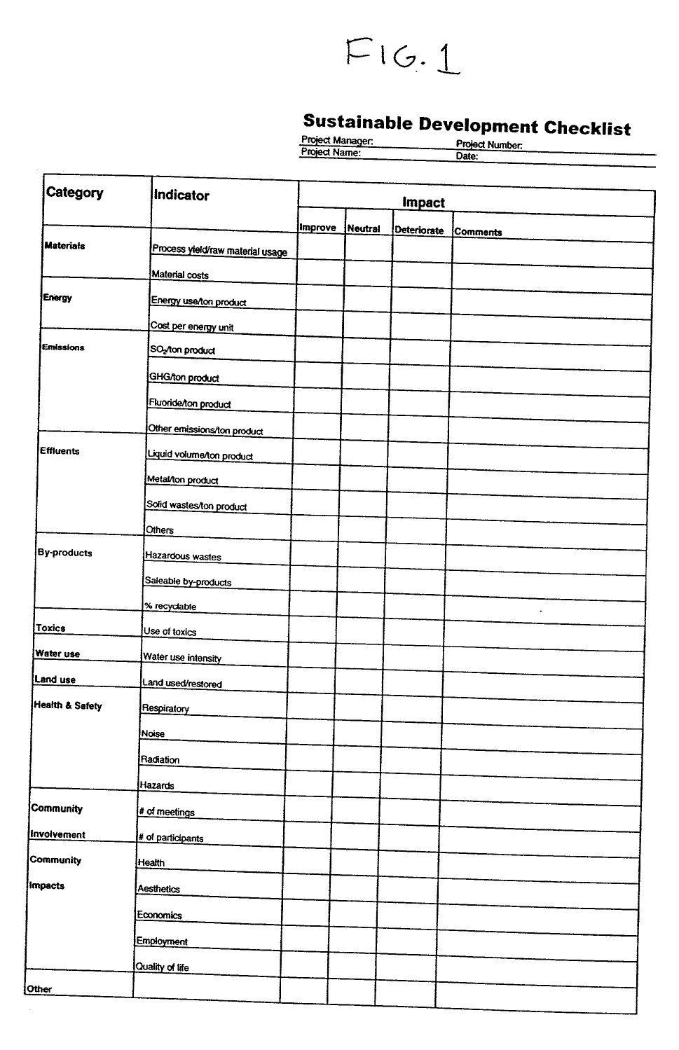

A method according to the first preferred embodiment of the present invention will now be described below with reference to FIG. 1. The first preferred embodiment comprises a preferred method for tracking the impact of a single capital project on an existing industrial facility.

FIG. 1 comprises a checklist containing twelve categories, at least eight of which relate to direct impacts of an industrial activity, namely: materials, energy, emissions, effluents, by-products, toxics, water use and land use. A number of the remaining categories listed on the checklist relate to social impacts such as health and safety, community involvement and community impacts, which have direct impacts on the health and safety of workers and the community as a whole, and therefore affect sustainability of the community including the intended new activity. The final category on the checklist is for insertion of other indicators not specifically related to any of the other listed categories, but which relate to the principles of sustainable development, such as enterprise-specific sustainability goals or to reflect local sensitivities.

Associated with each of the first eleven categories in the checklist of FIG. 1 is at least one indicator. The indicators are factors associated with the activity which would be expected to affect the environmental and social impact of the activity and which are therefore relevant to sustainability. For example, a typical industrial process converts a raw material to a saleable product, using some sort of energy to effect the conversion and also producing by-products which may be sold, recycled or disposed of, as well as gaseous emissions and liquid and/or solid effluents which may be released into the environment. For this type of process, the checklist might be expected to list indicators such as those contained in FIG. 1, particularly relating to the first eight categories in the checklist. Preferably, indicators are selected for which data already exists or can be readily obtained. For example, much of the data relating to the first eight categories would be pre-existing data which would result from an economic analysis of the process, or which may be required from a regulatory standpoint.

Once the indicators have been identified, data relating to each of the indicators is collected and analysed and a value is assigned to each of the indicators. Typically, although not necessarily, indicators are selected which lend themselves to quantification by a numerical value. For example, data relating to the amount of energy consumed and the amount of product produced over a given period of time are easily converted to a numerical value representing the energy use per ton of product.

Other indicators listed on the checklist of FIG. 1 lend themselves less readily to quanitification, for example the indicators relating to the health and safety category. These indicators may be quantified by use of a scale which assigns a numerical value to the indicator based on collected data relating to that indicator. The indicators relating to the “Community Impacts” category may be similarly quantified.

It will be appreciated that it is not always desirable or necessary that the method of the invention provide a quantitative result. This is particularly true in the early stages of a capital project where some of the data for some of the indicators may not be available. Under these circumstances, it will not be necessary to quantify all of the indicators. In general, it will always be possible to identify if the proposed activity will improve, degrade or have no impact on sustainability.

After values are assigned to the indicators, the values are converted into scores which are utilized to assess the overall impact of the activity. There are several ways to convert the values into scores, which are now discussed below.

The usual manner of converting the values into indicator scores is to compare the value of the indicator with a standard value for that indicator, to determine whether the value of the indicator is better orworse than the standard or whether it is the same. The standard may be a government or industry standard for that indicator, or may be a previously measured value for that indicator where the method of the invention is being repeated to track changes in the impact over time.

In the example shown in FIG. 1, the checklist contains three columns labelled “Improve”, “Neutral” and “Deteriorate”. After the values of the indicators are compared to the applicable standards, a check is placed into the relevant box, thus providing the score for each indicator. The checks in each of these three columns are then added in order to determine the overall environmental impact of the industrial activity. For example, where the check marks in the “Improve” column outnumber the check marks in the “Deteriorate” column, the project can be considered to have an overall positive impact on sustainability issues and, where potential deterioration is identified, it can be addressed.

As mentioned above, the method of the invention is preferably used to track the environmental impact of the activity over a period of time. The method is preferably first performed at the completion of project conception, before significant financial resources are committed, in the event it is necessary to make improvements in the project. The method is then preferably repeated on a periodic basis throughout the duration of the product in order to track changes in the impact of the product and to track its overall impact on the facility.

A second preferred embodiment of the invention is now described below. The second preferred embodiment addresses the situation in which a number of capital projects are simultaneously being carried out in a single facility, such as the industrial facility discussed in the first embodiment, and in which it is desired to determine the overall impact of the capital projects on the facility.

Thus, in the second preferred embodiment of the invention, the results of the individual analyses performed for each of the capital projects are combined and aggregated. This is most conveniently done by using the existing checklists as shown in FIG. 1, which have been generated for each individual project. For example, to determine the impact on sustainability of a number of projects, the total number of check marks in the “Improve” columns of all the checklists is counted, and compared to the total number of check marks in the “Deteriorate” columns of all the checklists. Thus, the aggregate impact of a number of capital projects can conveniently be determined according to the second embodiment of the present invention.

If it is also desired to track changes in the overall impact of a number of projects, this can simply be accomplished by repeating the above step periodically, using checklists generated at roughly the same time from a number of projects.

It will be appreciated that the method described above for determining the overall impact of a number of projects is not dependent on the nature of the indicators selected for each specific project. Rather, it is expected that the indicators are selected on a project-by-project basis and that the indicators selected are those which will have the greatest impact on sustainability. Thus, it will be appreciated that the indicators may vary from project to project. It is also possible to combine the scores with a measure of capital cost commitment to represent the potentially bigger impact of bigger projects.

Having now described a method for aggregating the results for individual projects to generate an aggregate result representative of the impact on sustainability of a number of projects being carried out at a given facility, it will be readily apparent that the same type of aggregation could be performed in order to assess the overall impact of a number of facilities in a division, to assess the overall impact of a number of divisions within an organization, and to assess the overall impact of the organization itself. Further, in the same manner described above, the analyses could be performed on a periodic basis to track changes in the impact of the facilities in a division, the divisions in an organization, and the organization itself.

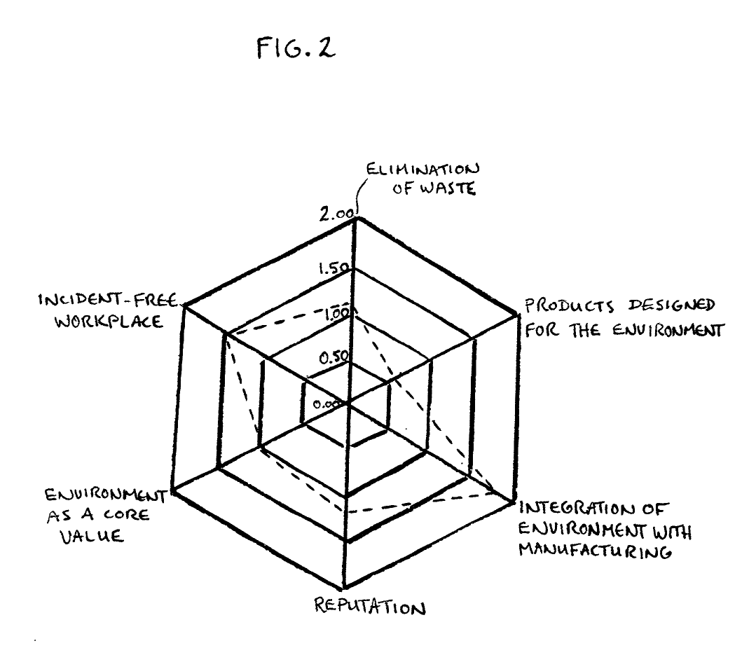

The method of the invention is particularly well suited to the type of graphic representation shown in FIG. 2, showing an aggregate sustainability score for an organization. The aggregate score is broken down over six categories, each of which is a major sustainability policy element of the organization, and each of which is represented by an axis. The six axes all emanate from a common origin. Lines connecting the axes at points equidistant from the origin form a series of concentric hexagons, each of which is representative of a level of sustainability, from zero at the origin to 2.0 at the outermost hexagon. The aggregate scores for each category are plotted along the relevant axis, and a line (the dashed line in FIG. 2) is drawn between these points representing the aggregate sustainability score. In the example shown, zero represents a negative or deteriorating impact on sustainability, 1.0 represents a neutral impact, and 2.0 represents a positive or improving impact on sustainability. The line representing the aggregate sustainability score is irregularly shaped, thereby representing a positive or improving impact on sustainability in some categories (eg. “Integration of Environment with Manufacturing”), a negative or worsening impact in some categories (eg. “Products Designed for the Environment”) and a neutral or substantially neutral impact in other categories. Thus, FIG. 2 highlights areas in which the organization is performing well in terms of sustainability, and areas in which improvement is needed.

In the context of the checklist shown in FIG. 1, the categories shown therein could be grouped as follows to provide a diagram similar to that of FIG. 2: the general category “Environmental Integration” could aggregate the Emissions, Effluents, Water Use and Land Use categories of FIG. 1; a broad category called “Resource Use Reduction” could aggregate Material Use, ByProducts and Energy Use; a broad category called “Toxics Elimination” could include Toxics; a broad category called “Community Development” could aggregate Community Involvement and Community Impact; and “Loss-free Workplace” could include Health and Safety”.

Although the preferred embodiments of the invention have described a method for assessing the impact of one or more capital projects on one or more industrial facilities, the method of the invention is not restricted to such embodiments. Rather, the invention can be used to assess the impact on sustainability of other activities such as capital spending or an operating change in an existing facility. As well, the method of the invention can be used to assess the sustainability of a new facility, also referred to above as a “greenfields” project, by analyzing the indicators relating to operation of the facility which would be expected to have an impact on sustainability. The analysis would be performed in the manner described above in the context of a capital project.

It will be appreciated that repetition of the above-described analysis over a period of time by individuals involved in making decisions impacting sustainability, will have the effect of educating these individuals as to the types of factors which have an impact on sustainability and their importance. This will result in sustainability issues being considered at all levels of decision making over the range of an organization's activities, thus permitting the organization to realize its corporate goals of attaining or moving toward sustainability. For example, each and every project can be managed to only create a positive impact on enterprise or institution sustainability.

Although the invention has been described with reference to certain preferred embodiments, it is not limited thereto. Rather, the invention includes all embodiments which may fall within the scope of the following claims.

What is claimed is:

1. A method for assessing the impact of an activity, comprising:
(a) identifying a plurality of quantifiable indicators which together are representative of the impact of said activity;
(b) analysing data to assign a value to each of the indicators;
(c) converting the value of each said indicator to an indicator score; and
(d) compiling the indicator scores to generate a composite score representative of the impact of the activity.

2. The method of claim 1, further comprising periodic repetition of steps (a), (b), (c) and (d) to determine how the impact of the activity changes over time.

3. The method of claim 1, wherein the value of at least one of said indicators is converted to an indicator score by comparing the indicator quantity obtained in step (b) to a standard value for said indicator.

4. The method of claim 2 wherein, after at least one repetition of steps (a), (b), (c) and (d), the indicator score for at least one of said indicators is obtained by comparing the value obtained in step (b) or the indicator score obtained in step (c) with previously obtained values of the indicator quantity and the indicator score, respectively.

5. The method of claim 1, wherein the activity is an industrial or infrastructure development activity and each of said indicators falls into a general category selected from the group comprising materials, energy, emissions, effluents, byproducts, toxics, water use, land use and restoration, health and safety, community involvement and community impacts and other indicators of local relevance.

6. The method of claim 5, wherein the industrial or infrastructure development activity comprises a capital project designed to change or expand the operation of an existing facility.

7. The method of claim 6, wherein at least one of said indicator scores is obtained by comparing the value of one of said indicators prior to implementation of the capital project with the value of that indicator after implementation of the capital project.

8. The method of claim 7, wherein the scores for a plurality of said indicators are aggregated to obtain an aggregate score for said facility.

9. The method of claim 8, wherein scores for a number of facilities within a division or an organization are aggregated to obtain an aggregate score for the division or the organization.

10. The method of claim 8, wherein the aggregate scores are monitored over time to monitor compliance with policies and progress towards sustainability.
